(19) United States
(12) Patent Application Publication
(10) Pub. No.: US 2026/0039236 A1
(43) Pub. Date: Feb. 5, 2026

(54) POOL CLEANERS WITH SOLAR POWER SYSTEMS AND METHODS

(71) Applicant: ZODIAC POOL CARE EUROPE, Belberaud (FR)

(72) Inventors: Thomas Manoury, Belberaud (FR); Louis Favié, Colomiers (FR)

(73) Assignee: ZODIAC POOL CARE EUROPE, Belberaud (FR)

(21) Appl. No.: 19/285,199

(22) Filed: Jul. 30, 2025

Related U.S. Application Data
(60) Provisional application No. 63/677,776, filed on Jul. 31, 2024.

(51) Int. Cl. H02S 10/40; E04H 4/16; H02S 30/00

(52) U.S. Cl. CPC H02S 10/40; E04H 4/1654; H02S 30/00

(57) ABSTRACT

A self-propelled pool cleaner operable and submergible in a swimming pool or spa includes an onboard power-generating device, such as but not limited to one or more solar panels. The one or more solar panels may be on a submergible surface of the self-propelled pool cleaner, such as but not limited to a surface at a top end of the self-propelled pool cleaner and/or one or more sidewalls. The one or more solar panels may allow for charging of the self-propelled pool cleaner at least while the pool cleaner is submerged underwater.

### REFERENCE TO RELATED APPLICATION

This application claims the benefit of and priority to U.S. Provisional Patent Application No. 63/677,776, filed on Jul. 31, 2024, and entitled POOL CLEANERS WITH SOLAR POWER SYSTEMS AND METHODS, the content of which is hereby incorporated by reference in its entirety.

### FIELD OF THE INVENTION

The invention relates to self-propelled swimming pool cleaners and other robots or cleaners, and more particularly, to systems and methods for cleaners with on-board power-generating devices.

### BACKGROUND OF THE INVENTION

Numerous self-propelled cleaning devices capable of autonomous or semi-autonomous movement within swimming pools and spas currently exist. The most common of these devices are pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Battery-driven pool cleaners are becoming increasingly popular as they may omit the cord or cabling traditionally required for connecting the pool cleaner to an external power source outside of the water of the swimming pool. While such cabling is omitted, battery-driven pool cleaners are only operable while the battery is sufficiently charged. Thus, compared to corded pool cleaners, battery-driven pool cleaners may require charging at various time intervals or frequencies utilizing charging stations. Such time intervals or frequencies may depend on the duration of the cleaning cycle and/or other activities performed by the pool cleaner. Regardless of the type of charging station, traditional approaches to charging or powering a pool cleaner rely on appropriate docking with external devices or systems to connect with an external power source.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a self-propelled, submergible pool cleaner includes an onboard solar panel.

According to some embodiments, a self-propelled, submergible pool cleaner includes a solar panel on a top end of the pool cleaner.

According to various embodiments, a self-propelled pool cleaner for a swimming pool or spa includes a solar panel submergible with the pool cleaner underwater.

According to certain embodiments, a self-propelled pool cleaner may be configured to (i) travel along a submerged surface of a pool or spa and/or (ii) perform a cleaning operation on the submerged surface, and the pool cleaner includes a solar panel.

According to various embodiments, a self-propelled pool cleaner includes a body and a solar panel attachable to and removable from the body.

According to some embodiments, pool equipment for a swimming pool or spa, wherein the pool equipment includes a surface which is at least partially submergible within a pool or spa, and wherein the pool equipment includes a solar panel on the surface.

According to certain embodiments, a pool cleaner system includes a pool cleaner with an onboard battery, a float with a solar panel; and a connection system electrically connecting the solar panel with the onboard battery of the pool cleaner.

According to various embodiments, a pool cleaner system includes a pool cleaner with an onboard battery, a float with a solar panel and a solar panel battery, and a connection system enabling selective electrical connection between the pool cleaner and the float, wherein the pool cleaner is detachable from the connection system.

According to certain embodiments, a pool cleaner includes a disconnectable power supply, and the disconnectable power supply includes a solar panel or a solar panel battery.

According to certain embodiments, a pool cleaner includes an onboard power-generating device.

According to some embodiments, a method includes charging or powering a pool cleaner using an onboard solar panel. The onboard solar panel is capable of selectively charging the pool cleaner at a plurality of locations of the pool cleaner, and the plurality of locations include, but are not limited to, a submerged location a pool or spa, a location at a waterline of the pool or spa, and/or a location outside of the pool or spa.

According to various embodiments, a method includes controlling a pool cleaner with an onboard solar panel to end a cleaning cycle in a center of a pool.

According to certain embodiments, a method includes determining a position or orientation of a solar panel onboard a pool cleaner or on a float relative to a position of the sun, and adjusting the position or orientation of the solar panel to face the position of the sun.

According to various embodiments, a method includes monitoring or measuring sunlight or light intensity in a pool or spa, and controlling a pool cleaner with an onboard solar panel or a disconnectable float with a solar panel to navigate to a position in the pool or spa where the monitoring or measured sunlight or light intensity meets a predefined criteria and/or meets a sunlight or light intensity threshold.

According to some embodiments, a method includes determining a time of day using a solar panel onboard a pool cleaner.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system with a self-propelled pool cleaner and a power-generating device according to embodiments.

FIG. 2 is another view of the pool system of FIG. 1 according to embodiments.

FIG. 3 is another view of the pool system of FIG. 1 according to embodiments.

FIG. 4 is another view of the pool system of FIG. 1 according to embodiments.

FIG. 5 is another view of the pool system of FIG. 1 according to embodiments.

### DETAILED DESCRIPTION

Described herein are systems and methods for providing pool cleaners with one or more onboard power-generating devices. In certain embodiments, the onboard power-generating devices may include one or more solar panels. The one or more solar panels may be on the pool cleaner and/or operable underwater (e.g., they may allow charging even while underwater). In certain embodiments, the systems and methods described herein provide a pool cleaner with a solar panel that is submerged or submergible with the pool cleaner. Additionally, or alternatively, other pool equipment for a swimming pool or spa may include a surface that is submergible, and the equipment includes one or more solar panels on the submergible surface. In a non-limiting example, a pool cleaner may include one or more solar panels at a top end of the pool cleaner.

In various embodiments, the solar panel on the pool cleaner may generate energy while the pool cleaner is submerged, at a waterline (e.g., partially submerged), and/or outside of the pool or spa. In some embodiments, the solar panel may be removable or detachable from the pool cleaner, although it need not be in other embodiments. In certain embodiments, the solar panel may be adjustable relative to the pool cleaner. Optionally, the solar panel may be self-adjusting to automatically control an orientation or position of the solar panel on the pool cleaner relative to a position of the sun.

In some embodiments, the systems and methods described herein provide a pool cleaner system with a pool cleaner and a float having one or more solar panels (and optionally a solar panel battery and/or one or more sensors). In certain embodiments, the solar panel of the float is electrically connected to a battery of the pool cleaner such that electrical energy may be transferred from the solar panel to the battery of the pool cleaner. In some embodiments, the float with the one or more solar panels is detachable from the pool cleaner.

Compared to traditional charging solutions, the systems and methods described herein may allow for a pool cleaner to power itself and/or charge or recharge onboard batteries without requiring docking or engagement with an external device. In certain embodiments, the systems and methods described herein may provide pool cleaners with improved autonomy to function within a pool system, optionally allowing the pool cleaner to minimize or reduce reliance upon a user and/or external devices. In certain embodiments, the power generated by the onboard power-generating device may be utilized to power the entire pool cleaner or sub-components thereof (e.g., communication systems on the pool cleaner, sensor systems on the pool cleaner, combinations thereof, etc.). Various other benefits and advantages may be realized with the systems, devices, and methods provided herein, and the aforementioned advantages should not be considered limiting.

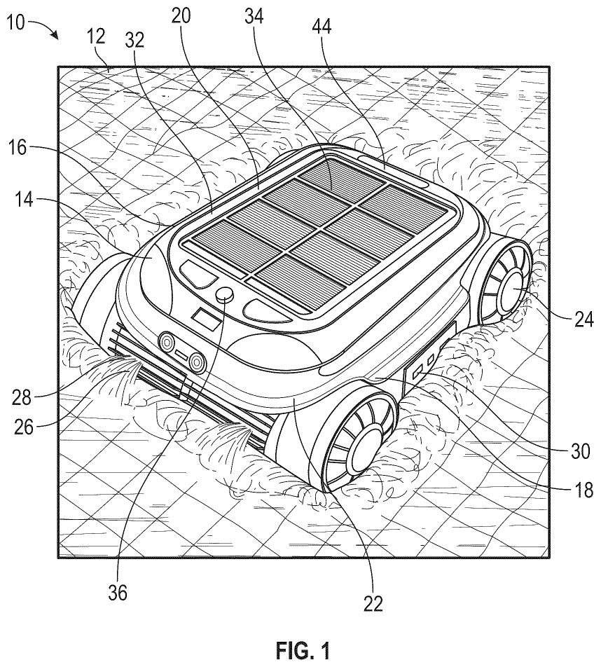

FIGS. 1-5 illustrate a pool system 10 with a pool 12 and one or more pieces of pool equipment 14 according to embodiments. The pool 12 may have various shapes, sizes, and dimensions, as desired, and those illustrated in FIGS. 1-5 should not be considered limiting.

The pool equipment 14 may be various types of pool equipment 14 capable of self-propelled movement (e.g., autonomous or semi-autonomous movement) within the pool 12, such as but not limited to one or more pool cleaners, skimmers, floating devices, combinations thereof, and/or as otherwise desired. The number of pieces of pool equipment 14 provided with the pool system 10 should not be considered limiting, and embodiments with a plurality of pieces of pool equipment 14 may include similar or dissimilar equipment as desired. In certain embodiments, the pool equipment 14 may be equipment configured to travel along one or more submerged surfaces of the pool 12 and/or configured to perform a cleaning operation on one or more submerged surfaces of the pool 12.

In one non-limiting example, the pool equipment 14 may be various types of self-propelled pool cleaners 16 as desired and is not limited to the examples disclosed herein. As non-limiting examples, the pool cleaners 16 may be robotic pool cleaners, hydraulic, combinations thereof, and/or as otherwise desired. In certain embodiments, and as illustrated in FIGS. 1-5, a pool cleaner 16 generally includes a body 18 which is movable relative to (e.g., along) one or more submerged surfaces of the pool 12. In certain embodiments, the body 18 may be formed by a chassis 30 and a housing 32, although it need not in other embodiments, and the body 18 may have other constructions as desired. While the body 18 may have various shapes, sizes, or configurations as desired, in some embodiments, and as illustrated in FIG. 1, the body 18 includes a nominal top end 20 and one or more sidewalls 22. The pool cleaner 16 may include optional motive elements 24, which may be various suitable devices or structures suitable for enabling movement of the pool cleaner 16 along a surface. Non-limiting examples of motive elements 24 include, but are not limited to, wheels, rollers, feet, tracks, propellers, combinations thereof, and/or other suitable motive elements 24 as desired.

The pool cleaner 16 may include various components on and/or within the body 18 such as but not limited to a motor block, a filter, a pump, a controller, combinations thereof, and/or as otherwise desired. The pool cleaner 16 optionally may include one or more cleaning elements 26 (e.g., a brush assembly 28 with one or more brushes) suitable for cleaning a surface and/or directing debris into the pool cleaner 16 and/or towards a filter of the pool cleaner 16.

In various embodiments, the pool cleaner 16 includes one or more communication modules allowing for wireless communication (e.g., Bluetooth, Li-Fi, LoRa, radio frequency, cellular, NFC, Wi-Fi, etc.) with external or remote devices such as external control devices, the internet, cloud services, smartphones, other user devices, etc.

In some embodiments, the pool cleaner 16 may include one or more onboard batteries for storing energy. The onboard batteries may be provided at various locations on or within the pool cleaner 16 as desired. As non-limiting examples, the onboard batteries may be provided within the body 18 and/or may at least partially form an outer surface of the pool cleaner 16.

In certain embodiments, the pool cleaner 16 may include a controller with one or more processing units and/or one or more memory devices on and/or associated with the pool cleaner 16. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

However, as mentioned, the pool cleaner 16 illustrated should not be considered limiting as the autonomous pool cleaner 16 described herein may be used with other types of pool cleaners with fewer, additional, or various other combinations of features as desired, and in other embodiments the autonomous pool cleaner 16 itself may be configured as a pool cleaner as described below. Other non-limiting examples of pool cleaners 16 may include those described in U.S. Pat. Nos. 10,316,534, 9,488,154, 8,578,538, and U.S. Patent Publication No. 2014/0303810, all of which are hereby incorporated by reference in their entireties.

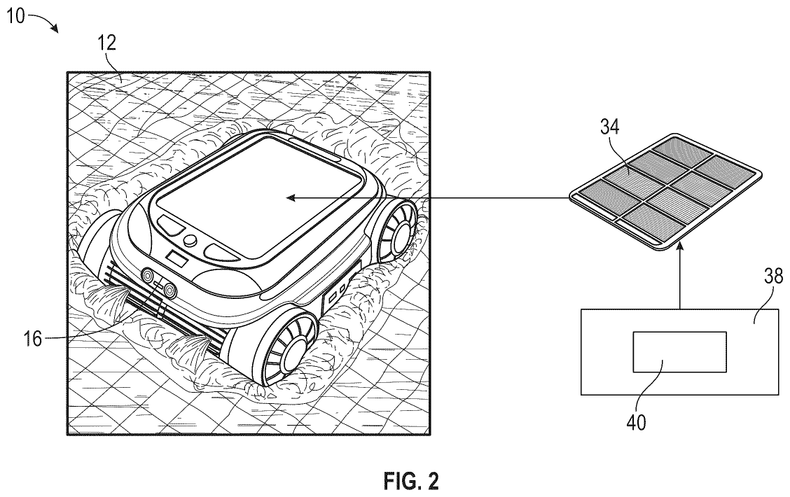

Referring to FIGS. 1 and 2, in certain embodiments, the pool cleaner 16 (or pool equipment 14 in general) includes one or more onboard power-generating devices, such as but not limited to one or more onboard solar panels 34. While the following discussion makes references to the solar panels 34 on the pool cleaner 16, in other embodiments, solar panels 34 may be provided on other equipment as desired, and the discussion is equally applicable to other equipment 14 unless expressly stated otherwise.

The solar panels 34 may be movable with the pool cleaner 16 and thus are submerged or submergible with the pool cleaner 16. In certain embodiments, the one or more solar panels 34 are functional or operable underwater and/or on a device that is at least partially submerged. In some embodiments, the solar panels 34 are functional or operable (e.g., generate energy) at least while underwater, and in some embodiments, the solar panels 34 optionally are operable while the pool cleaner 16 is submerged, partially submerged (e.g., at a waterline), and/or outside of the pool 12.

Any number of solar panels 34 may be provided on the pool cleaner 16 as desired, and the number of solar panels 34 should not be considered limiting. In some embodiments, and as illustrated in FIG. 1, the solar panels 34 may be fixed or embedded with the pool cleaner 16, meaning that the solar panels 34 are not removable without damaging or destroying parts of the pool cleaner 16. In other embodiments, and as illustrated in FIG. 2, one or more solar panels 34 may be detachable from the pool cleaner 16. In these embodiments, the one or more solar panels 34 itself may be detachable and/or the one or more solar panels 34 may be provided on another part or component of the pool cleaner 16 which is detachable from the body 18. As a non-limiting example, the one or more solar panels 34 may be provided on a lid or cover of the pool cleaner 16 which is removable from the body 18.

Optionally, and as illustrated in FIG. 2, solar panels 34 which are detachable from the pool cleaner 16 may be provided with a charging base 38 for storage of the one or more solar panels 34. Additionally, or alternatively, the charging base 38 may be provided for storage of energy generated by the one or more solar panels 34 while the one or more solar panels 34 are detached from the pool cleaner 16. In this regard, the charging base 38 may include one or more stores of energy (e.g., one or more batteries 40) for storing energy generated by the solar panels 34 while detached from the pool cleaner 16. Optionally, the one or more batteries 40 may be used as the onboard batteries of the pool cleaner 16, although they need not be in other embodiments.

Regardless of whether the one or more solar panels 34 is embedded with the pool cleaner 16 or detachable from the pool cleaner 16, the one or more solar panels 34 may be provided at various locations on or within the pool cleaner 16 as desired. In some embodiments, one or more solar panels 34 may be provided on an outer surface of the body 18 and thereby at least partially form an outer surface of the pool cleaner 16. In certain embodiments, one or more solar panels 34 may be provided on a surface of the body 18 which is submergible within the pool 12. As a non-limiting example, in FIG. 1, the one or more solar panels 34 is provided on the top side 20 of the body 18; however, in other embodiments, the one or more solar panels 34 may be provided at other locations as desired, such as but not limited to one or more solar panels 34 on one or more sidewalls 22. In certain embodiments, the one or more solar panels 34 (and/or components thereof) may be arranged in a pattern or arrangement on the body 18 to optimize the conversion of sunlight into energy.

Additionally, or alternatively, the one or more solar panels 34 (and/or components thereof) may have various geometries or shapes as desired, optionally to optimize operation of the solar panels 34. As a non-limiting example, in some embodiments, the one or more solar panels 34 may be a flexible substrate shaped to conform to a surface of the pool cleaner 16. Additionally, or alternatively, the flexible one or more solar panels 34 may be coupled to a deformable surface and/or a non-linear surface to modify a radius of curvature of the flexible one or more solar panels 34 and thereby optimize light conversion at the location of the flexible one or more solar panels 34.

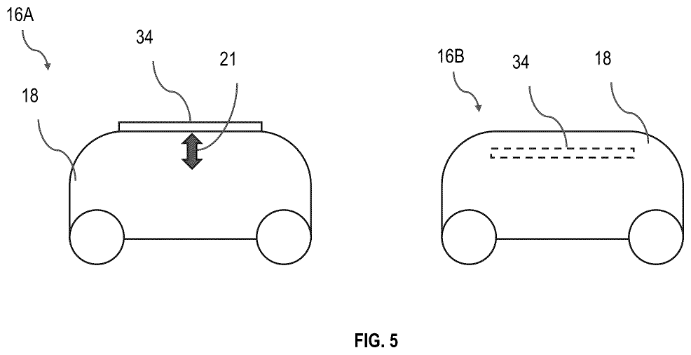

In some optional embodiments, and as illustrated in FIG. 5, the one or more solar panels 34 may be positioned or positionable in the body 18 (e.g., within the chassis 30 or the housing 32) when not in use, and the one or more solar panels 34 may be selectively deployed for use using various deployment systems or mechanisms as desired. As non-limiting examples, a retractable mechanism, slides, rollers, combinations thereof, and/or other devices or mechanisms as desired may be utilized to selectively stow or deploy the one or more solar panels 34 as desired. Additionally, or alternatively, a cover may be selectively deployed to cover the one or more solar panels 34 as desired without requiring movement of the solar panels 34 themselves. Other mechanisms or combinations thereof may be utilized as desired.

In various embodiments, and regardless of whether the one or more solar panels 34 is embedded with the pool cleaner 16 or detachable from the pool cleaner 16, the one or more solar panels 34 optionally may be adjustable or movable relative to the body 18.

In some embodiments, the movement or adjustment of the one or more solar panels 34 optionally includes movement or adjustment between stowed and deployed configurations. In certain embodiments, an exposed surface area of the one or more solar panels 34 in the deployed configuration is greater than the exposed surface area of the one or more solar panels 34 in the stowed configuration. In some embodiments, and as previously discussed, in the stowed configuration, the one or more solar panels 34 optionally may be housed partially or wholly within the body 18. However, in other embodiments, the one or more solar panels 34 need not be within the body 18 in the stowed configuration. As a non-limiting example, the one or more solar panels 34 may be provided on the top side 20 of the pool cleaner 16 and includes a plurality of panels. In this embodiment, in a stowed configuration, at least some of the panels may be stored or otherwise not deployed, and in a deployed configuration, the panels of the one or more solar panels 34 may be fanned out to increase the surface area of the one or more solar panels 34. As a non-limiting example, in FIG. 5, pool cleaner 16A includes the solar panel 34 in a deployed position and pool cleaner 16B illustrates the solar panel in a stowed position, with movement between the stowed and deployed positions represented by arrow 21. Other deployment and stowage systems and/or mechanisms may be utilized as desired. In embodiments where the one or more solar panels 34 is movable between stowed and deployed configurations, such movement may be controlled (e.g., by an onboard control system) automatically, responsive to a trigger event (e.g., an end of a cleaning cycle, a detected battery status, a scheduled time, an operational status, a navigational position within the pool, etc.), and/or responsive to a command from a user as desired.

Additionally, or alternatively, the one or more solar panels 34 may be movable or adjustable to control positioning and/or orientation of the one or more solar panels 34 relative to the sun and/or light rays. In these embodiments, the solar panel may be adjustable or movable via various mechanisms or techniques as desired, such as but not limited to tilting, angling, pivoting, rotating, bending, repositioning (e.g., to another location on the body 18), combinations thereof, and/or as otherwise desired. In some embodiments, the one or more solar panels 34 is automatically adjustable relative to the sun and/or light rays, while in other embodiments, the one or more solar panels 34 may be adjusted or moved by the user.

In some embodiments, the pool cleaner 16 and/or the one or more solar panels 34 may include one or more onboard sensors 36 configured to detect a position or orientation of the sun (e.g., a sun tracker sensor) and/or to detect light rays, such as but not limited to an intensity of light, incidence of light rays, combinations thereof, and/or as otherwise desired. In embodiments with such sensors 36, the sensors 36 may be provided at various locations on the pool cleaner 16 as desired. Optionally, based on the information sensed by the one or more sensors 36, the position and/or orientation of the one or more solar panels 34 may be automatically controlled (e.g., by the onboard control system). As a non-limiting example, the one or more solar panels 34 may be automatically tilted, angled, or bent to adapt to an angle of incidence of light rays and/or a change in position of the sun.

In certain embodiments, the solar panels 34 may be coupled with the one or more onboard batteries of the pool cleaner 16 (and/or directly to other components as desired) using various connection or coupling systems such as desired. As non-limiting examples, the solar panels 34 may be connected with one or more onboard batteries (and/or other components) using induction connections, wired connections, combinations thereof, and/or as otherwise desired. In some embodiments, the connections between the solar panels 34 and the components of the pool cleaner 16 are fixed. In other embodiments, the connections are suitable devices or mechanisms such that the one or more solar panels 34 is detachable from and/or may be electrically disconnected as desired.

Optionally, the one or more solar panels 34 include various features facilitating communication and/or interaction with a user and/or a user device. As a non-limiting example, in some embodiments, the one or more solar panels 34 may include a human machine interface (HMI) 44 with one or more features for providing information to a user and/or for receiving input from a user. The HMI 44 includes various features for receiving input from and/or providing output to a user, such as but not limited to a display, a speaker, a button, a switch, a dial, a keypad, a light source, combinations thereof, and/or as otherwise desired. The information provided to the user via the HMI 44 may be various information as desired. As another non-limiting example, in some embodiments, the one or more solar panels 34 may include a communication module facilitating wireless communication.

As mentioned, the one or more solar panels 34 may be operable for converting light to energy at various locations relative to the pool 12 as desired. As non-limiting examples, and referring to FIG. 2, the solar panels 34 may be operable while the pool cleaner 16 is submerged (see pool cleaner 16A), such as on a floor of the pool 12. In other embodiments, the solar panels 34 are operable while the pool cleaner 16 is outside of the pool 12 (see pool cleaner 16B).

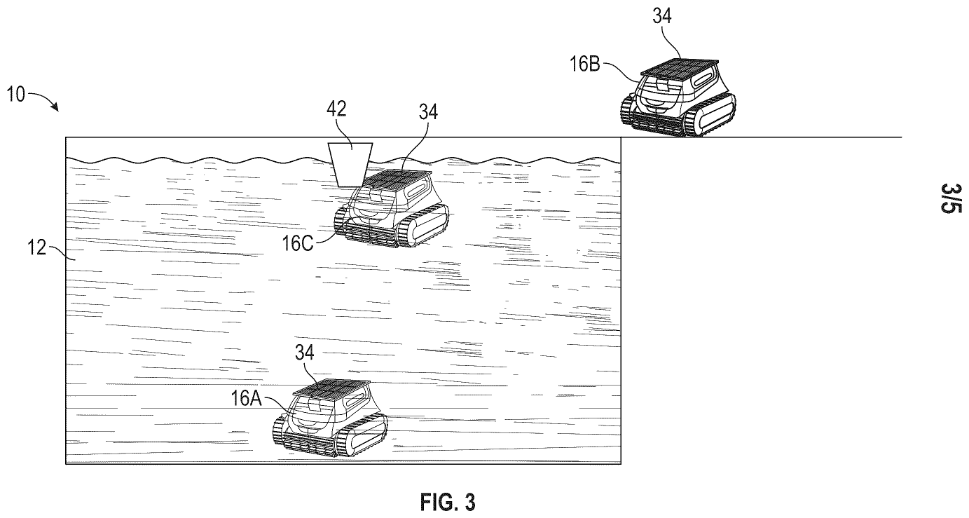

Additionally, or alternatively, the solar panels 34 may be operable while the pool cleaner 16 is partially submerged, such as but not limited to when the pool cleaner 16 is at a waterline of the pool 12 (see pool cleaner 16C). Optionally, at the waterline, the pool cleaner 16 may be coupled to a floatation system 42 (see, e.g., FIG. 3) to facilitate positioning of the pool cleaner 16 at the waterline. In other embodiments, the floatation system 42 may be omitted. In various embodiments, at the waterline, the one or more solar panels 34 on the pool cleaner 16 may be above the waterline, below the waterline, or both.

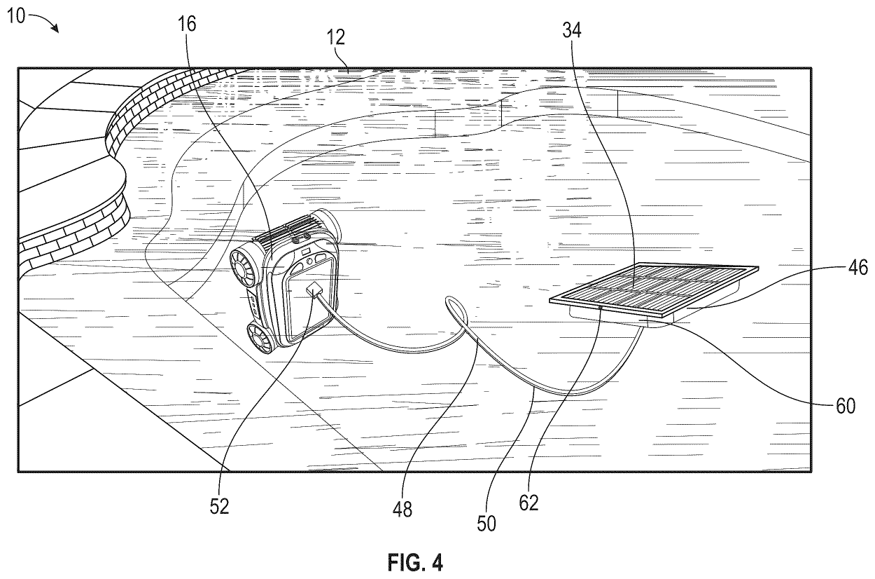

Referring to FIG. 4, in some embodiments, the pool system 10 optionally includes a float 46 with the one or more solar panels 34. In this embodiment, the pool cleaner 16 need not include onboard solar panels 34, although in certain embodiments the pool cleaner 16 may also have solar panels as discussed previously.

In certain embodiments, the float 46 with the one or more solar panels 34 may be electrically connected to the pool cleaner 15 via a connection system 48. In certain embodiments, the connection system 48 electrically connects the solar panel 34 on the float 46 with the battery onboard the pool cleaner 16, thereby allowing for the transfer of energy from the floating solar panel to the battery of the pool cleaner 16. In certain embodiments, the connection system 48 is a detachable system such that the battery of the pool cleaner 16 may be selectively connected to or disconnected from the floating solar panel 34 as desired. Optionally, the connection system 48 may include cabling 50 with at least one connector 52 engageable with the pool cleaner 16 such that the pool cleaner 16 may be connected to or disconnected from the float 46 with the one or more solar panels 34 as desired. Various types of connectors 52 may by utilized as desired, including induction connectors, wired connectors, mechanical connectors, combinations thereof, and/or as otherwise desired.

Optionally, the float 46 with the onboard one or more solar panels 34 includes an onboard solar panel battery 60. In these embodiments, when the pool cleaner 16 is disconnected from the solar panel 34 (and/or as otherwise desired), the one or more solar panel batteries 60 may store energy generated by the floating one or more solar panels 34.

Optionally, the float 46 with the one or more solar panels 34 additionally includes one or more sensors 62 for detecting or sensing information about the pool system 10. The sensors 62 may be various sensors as desired, such as but not limited to optical sensors, cameras, water presence sensors, water temperature sensors, water chemistry sensors, flow sensors, acoustic sensors, combinations thereof, and/or as otherwise desired. In one non-limiting example, the one or more sensors 62 includes a camera. In certain embodiments, the data obtained by the one or more sensors 62 may be communicated to the pool cleaner 16 and/or to a remote user device. In some embodiments, the data from the one or more sensors 62 may be utilized by the pool cleaner 16 to perform one or more cleaning and/or navigation operations. As a non-limiting example, a camera as the one or more sensors 62 on the float may detect debris within the pool 12 and a location of the debris in the pool 12, and the pool cleaner 16 may be controlled to navigate to the location of the debris based on the data from the camera. Other controls utilizing the sensor data may be utilized as desired.

In certain embodiments, in addition to performing cleaning operations and other traditional pool cleaner operations, the pool cleaner 16 may perform various processes or operations when it includes the one or more solar panels 34. Examples are described in greater detail below, but these processes should not be considered limiting, and in other embodiments, additional and/or alternative operations may be performed as desired.

In some embodiments, the pool cleaner 16 may utilize the one or more solar panels 34 as a light detector to determine a time of day. As a non-limiting example, based on a characteristic of the light received by the solar panels 34 (e.g., intensity, direction, luminosity, amount, etc.), the pool cleaner 16 may estimate or determine a time of day at the location of the pool cleaner 16.

Additionally, or alternatively, the pool cleaner 16 may perform various operations to optimize the use of the one or more solar panels 34. As a non-limiting example, a characteristic of light may be detected (e.g., by an onboard sensor), and based on the characteristic, the pool cleaner 16 may reposition itself and/or the solar panels 34. As a non-limiting example, the pool cleaner 16 may detect light intensity, and the pool cleaner 16 may position and/or orient itself and/or the solar panel 34 to face a direction of highest intensity, until the detected light intensity reaches a threshold, and/or until a location of the detected light intensity is determined to be a maximum within the pool. As another non-limiting example, the direction of the light (and thus the position of the sun) may be tracked, and the pool cleaner 16 may position and/or orient itself and/or the solar panel 34 to face the direction of the light.

As another non-limiting example, the pool cleaner 16 may identify a center of the pool 12 (using various localization and/or position sensing techniques) and may control itself to be positioned at the center of the pool 12 for charging. Additionally, or alternatively, the pool cleaner 16 may identify optimal locations within the pool 12 for charging using the one or more solar panels 34 by monitoring or detecting light intensity, shadows, sun positioning, combinations thereof, and/or as otherwise desired. In some embodiments, the pool cleaner 16 may position itself at the center of the pool 12 and/or the location determined to be optimal for charging automatically (e.g., at an end of a cycle, based on a battery level, combinations thereof, etc.) and/or as directed by a user.

Various other processes or controls may be implemented as desired, and the aforementioned examples should not be considered limiting. Moreover, various other benefits and advantages may be realized with the systems, devices, and methods provided herein, and the aforementioned advantages should not be considered limiting.

Exemplary concepts or combinations of features of the invention may include:
A. A pool cleaner for a swimming pool or spa, the pool cleaner comprising an onboard solar panel.
B. A pool cleaner for a swimming pool or spa comprising a solar panel submergible with the pool cleaner underwater.
C. A pool cleaner configured to (i) travel along a submerged surface of a pool or spa and/or (ii) perform a cleaning operation on the submerged surface, wherein the pool cleaner comprises a solar panel.
D. A pool cleaner comprising a body and a solar panel attachable to and removable from the body.
E. Pool equipment for a swimming pool or spa, wherein the pool equipment comprises a surface at least partially submergible within a pool or spa, and wherein the pool equipment comprises a solar panel on the surface.
F. A pool cleaner system comprising:
   i. a pool cleaner comprising an onboard battery;
   ii. a float comprising a solar panel; and
   iii. a connection system electrically connecting the solar panel with the onboard battery of the pool cleaner.
G. A pool cleaner system comprising:
   i. a pool cleaner comprising an onboard battery;
   ii. a float comprising a solar panel and a solar panel battery; and
   iii. a connection system enabling selective electrical connection between the pool cleaner and the float, wherein the pool cleaner is detachable from the connection system.
H. A pool cleaner comprising a disconnectable power supply, wherein the disconnectable power supply comprises a solar panel or a solar panel battery.
I. A pool cleaner comprising an onboard power-generating device.
J. A method comprising charging or powering a pool cleaner using an onboard solar panel, where the onboard solar panel is capable of selectively charging the pool cleaner at a plurality of locations of the pool cleaner, wherein the plurality of locations comprise a submerged location a pool or spa, a location at a waterline of the pool or spa, and/or a location outside of the pool or spa.
K. A method comprising:
   i. controlling a pool cleaner with an onboard solar panel to end a cleaning cycle in a center of a pool.
L. A method comprising:
   i. determining a position or orientation of a solar panel onboard a pool cleaner or on a float relative to a position of the sun; and
   ii. adjusting the position or orientation of the solar panel to face the position of the sun.
M. A method comprising:
   i. monitoring or measuring sunlight or light intensity in a pool or spa;
   ii. controlling a pool cleaner with an onboard solar panel or a disconnectable float with a solar panel to navigate to a position in the pool or spa where the monitoring or measured sunlight or light intensity meets a predefined criteria and/or meets a sunlight or light intensity threshold.
N. A method comprising determining a time of day using a solar panel onboard a pool cleaner.
O. A non-transitory computer readable storage medium comprising a plurality of instructions executable by one or more processors, the plurality of instructions comprising instructions which, when executed by the one or more processors, cause the one or more processors to perform actions including the method of any preceding or subsequent statement or combination of statements.
P. The pool cleaner, system, method, or storage medium of any preceding or subsequent statement or combination of statements, wherein the pool cleaner comprises a body with a top and sidewalls, and wherein the solar panel is on the top and/or on the sidewalls of the body.
Q. The pool cleaner, system, method, or storage medium of any preceding or subsequent statement or combination of statements, wherein the solar panel comprises a flexible shape.
R. The pool cleaner, system, method, or storage medium of any preceding or subsequent statement or combination of statements, wherein the solar panel is configured to charge a battery onboard the pool cleaner.
S. The pool cleaner, system, method, or storage medium of any preceding or subsequent statement or combination of statements, wherein the connection system comprises an induction connection.
T. The pool cleaner, system, method, or storage medium of any preceding or subsequent statement or combination of statements, wherein the connection system comprises a mechanical connection.
U. The pool cleaner, system, method, or storage medium of any preceding or subsequent statement or combination of statements, wherein the solar panel is positioned on a removable component of the pool cleaner.
V. The pool cleaner, system, method, or storage medium of any preceding or subsequent statement or combination of statements, wherein the solar panel is adjustable between a stowed configuration and a deployed configuration, wherein an exposed surface area of the solar panel in the deployed configuration is greater than the exposed surface area of the solar panel in the stowed configuration.
W. The pool cleaner, system, method, or storage medium of any preceding or subsequent statement or combination of statements, wherein the solar panel is automatically adjustable between the stowed configuration and the deployed configuration.
X. The pool cleaner, system, method, or storage medium of any preceding or subsequent statement or combination of statements, wherein, in the stowed configuration, the solar panel is within a body or a chassis of the pool cleaner.
Y. The pool cleaner, system, method, or storage medium of any preceding or subsequent statement or combination of statements,
Z. The pool cleaner, system, method, or storage medium of any preceding or subsequent statement or combination of statements, wherein at least one of an orientation, a position, a radius of curvature, or a shape of the solar panel is adjustable.
AA. The pool cleaner, system, method, or storage medium of any preceding or subsequent statement or combination of statements, wherein the onboard power-generating device comprises one or more solar panels.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “102A” refers to an instance of a device class, which may be referred to collectively as devices “102” and any one of which may be referred to generically as a device “102.”

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A self-propelled pool cleaner for a swimming pool or spa comprises an onboard solar panel, wherein the pool cleaner is submergible underwater.

2. The self-propelled pool cleaner of claim 1, wherein at least one of an orientation, a position, a radius of curvature, or a shape of the solar panel is adjustable.

3. The self-propelled pool cleaner of claim 1, wherein the pool cleaner comprises a body with a top and sidewalls, and wherein the solar panel is on the top and/or on the sidewalls of the body.

4. The self-propelled pool cleaner of claim 1, wherein the pool cleaner is configured to (i) travel along a submerged surface of a pool or spa and/or (ii) perform a cleaning operation on the submerged surface.

5. The self-propelled pool cleaner of claim 1, wherein the onboard solar panel is configured to generate energy for the pool cleaner while the solar panel is submerged.

6. The self-propelled pool cleaner of claim 1, wherein the solar panel comprises a flexible shape.

7. The self-propelled pool cleaner of claim 1, wherein the solar panel is configured to charge a battery onboard the pool cleaner.

8. The self-propelled pool cleaner of claim 1, wherein the solar panel is automatically adjustable between the stowed configuration and the deployed configuration.

9. Pool equipment for a swimming pool or spa, wherein the pool equipment comprises a surface at least partially submergible within a pool or spa, and wherein the pool equipment comprises a solar panel on the surface.

10. The self-pool equipment of claim 9, wherein at least one of an orientation, a position, a radius of curvature, or a shape of the solar panel is adjustable.

11. The pool equipment of claim 9, wherein the pool equipment comprises a self-propelled pool cleaner.

12. The pool equipment of claim 9, wherein the surface is a top surface of the pool equipment.

13. The pool equipment of claim 9, wherein the solar panel is configured to generate energy while submerged.

14. The pool equipment of claim 9, wherein the solar panel is configured to charge a battery onboard the pool equipment.

15. A self-propelled pool cleaner for a swimming pool or spa comprises:
a body comprising a top end and one or more sidewalls; and
a solar panel on the top end or the one or more sidewalls, wherein the solar panel is submergible underwater.

16. The self-propelled pool cleaner of claim 15, wherein the solar panel is positioned on a removable component of the pool cleaner.

17. The self-propelled pool cleaner of claim 15, wherein the onboard solar panel is configured to generate energy for the pool cleaner while the solar panel is submerged.

18. The self-propelled pool cleaner of claim 15, wherein the solar panel is on the top end.

19. The self-propelled pool cleaner of claim 15, wherein the solar panel is automatically adjustable between the stowed configuration and the deployed configuration.

20. The self-propelled pool cleaner of claim 15, wherein at least one of an orientation, a position. a radius of curvature, or a shape of the solar panel is adjustable.
